(19) United States
(12) Patent Application Publication
(10) Pub. No.: US 2025/0061315 A1
(43) Pub. Date: Feb. 20, 2025

(54) GROUPWISE ENCODING OF NEURAL NETWORKS

(71) Applicant: Cypress Semiconductor Corporation, San Jose, CA (US)

(72) Inventor: Elias Trommer, Berlin (DE)

(73) Assignee: Cypress Semiconductor Corporation, San Jose, CA (US)

(21) Appl. No.: 18/451,960

(22) Filed: Aug. 18, 2023

(51) Int. Cl. G06N 3/0495

(52) U.S. Cl. CPC G06N 3/0495

(57) ABSTRACT

Methods and systems for groupwise encoding for neural networks. The disclosed method includes, among other things, receiving a sparse array associated with a trained machine-learning model to be stored in memory, identifying a plurality of groupings of elements from the sparse array, wherein each element of a grouping is equidistantly positioned in the sparse array, generating a group data structure including a respective grouping, an offset of a respective grouping in the sparse array, and a distance between each element of the respective grouping in the sparse array for each grouping of the plurality of groupings, and storing each group data structure associated with the plurality of groupings in memory.

### TECHNICAL FIELD

Aspects and implementations of the present disclosure relate to groupwise encoding for neural networks.

### BACKGROUND

Neural networks have become an integral part of numerous technological applications, ranging from image and speech recognition to natural language processing, autonomous vehicles, and beyond.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is an exemplary illustration of the groupwise encoding of a sparse array of a trained neural network, in accordance with implementations of the present disclosure.

FIG. 3 is an exemplary illustration of the groupwise encoding of a sparse array of a trained neural network, in accordance with implementations of the present disclosure.

FIG. 4 is an exemplary illustration of the groupwise encoding of a sparse array of a trained neural network, in accordance with implementations of the present disclosure.

FIG. 5 depicts a flow diagram of an example method for groupwise encoding of neural networks, in accordance with implementations of the present disclosure.

FIG. 6 depicts a flow diagram of an example method for groupwise encoding of neural networks, in accordance with implementations of the present disclosure.

FIG. 7 is a block diagram illustrating an exemplary computer system, in accordance with implementations of the present disclosure.

### DETAILED DESCRIPTION

Aspects of the present disclosure relate to groupwise encoding of groupwise encoding for neural networks. Neural networks, such as artificial neural network (ANN) or simulated neural network (SNN), are an interconnected group of natural or artificial neurons that uses a mathematical or computational model for information processing to model complex relationships between inputs and outputs or to find patterns in data. The design of neural networks typically involves a large number of parameters so that they can learn complex patterns in data. Due to their large size and complexity, they are resource-intensive in terms of computing power, memory, and storage, making them unsuitable for small devices like microcontrollers or mobile devices.

Traditionally, by pruning, neural networks can be reduced in size and complexity, which involves removing weights or neurons that do not contribute to the network's overall performance. Pruning can reduce networks' memory, storage, and computation requirements while maintaining performance by removing unnecessary weights or neurons. These conventional methods, however, often result in sparse and irregular weight tensors, which can be challenging to handle efficiently. Hardware architectures are typically optimized for dense data structures and regular memory access patterns. Therefore, the irregular sparsity pattern resulting from conventional methods leads to inefficient memory access and computation, negating some of the benefits of pruning.

Some solutions include dedicated hardware in the devices optimized for reconstructing the pruned network to address irregular sparsity. While dedicated hardware increases computational efficiency and reduces memory consumption, it can also increase the complexity and overall cost of devices. Other solutions involve exploiting the sparsity by representing the sparse matrices in a memory-efficient manner. Typical formats for representing the sparse matrices in a memory-efficient manner includes Compressed Sparse Row (CSR) encoding and Run-length encoding.

Compressed Sparse Row (CSR) typically stores the non-zero elements and their indices, which allows for skipping over the zeros when performing computations. However, a large amount of memory overhead is required for encoding.

Run-length encoding traditionally comprises a sequence of non-zero components (e.g., value sequence) accompanied by a series of counts (e.g., zeros sequence), indicating the number of zeros interspersed between non-zero elements. This method can be particularly efficient, as the zeros in a sparse structure typically outnumber the non-zero elements significantly, and the counts can generally be represented using fewer bits than the original data. However, recovering the original array requires scanning through the ‘zeros’ and ‘values’ sequences, which can be inefficient due to the inherent nature of the non-parallel operation.

Aspects and embodiments of the present disclosure address these and other limitations of the existing technology by enabling systems and methods of identifying one or more groupings of elements from a sparse array associated with a trained neural network that is equidistantly positioned within the sparse array and generating a group encoding for each grouping. More specifically, each grouping of elements is identified using a group size of a plurality of group sizes, a distance value of a plurality of distance values, and an offset within the sparse array. Each grouping represents a set of elements that were each separated by an integer multiple of the distance value starting from the offset in the sparse array. The group encoding includes the set of elements of the grouping, the offset in the sparse array associated with a position of the first element of the set of elements, and the distance value used to generate the grouping. Each group encoding stored in memory for later reconstruction. In some implementations, reconstruction of the group encoding may include allocating a data buffer of the original array and inserting, for each group encoding, elements of a respective group encoding into the data buffer from the offset of the respective group encoding every distance value of the respective group encoding.

Aspects of the present disclosure overcome these deficiencies and others by reducing memory and/or storage requirements for storing the sparse array associated with the trained neural network, providing parallelization for the reconstruction of the sparse array, thereby eliminating the need for additional dedicated hardware.

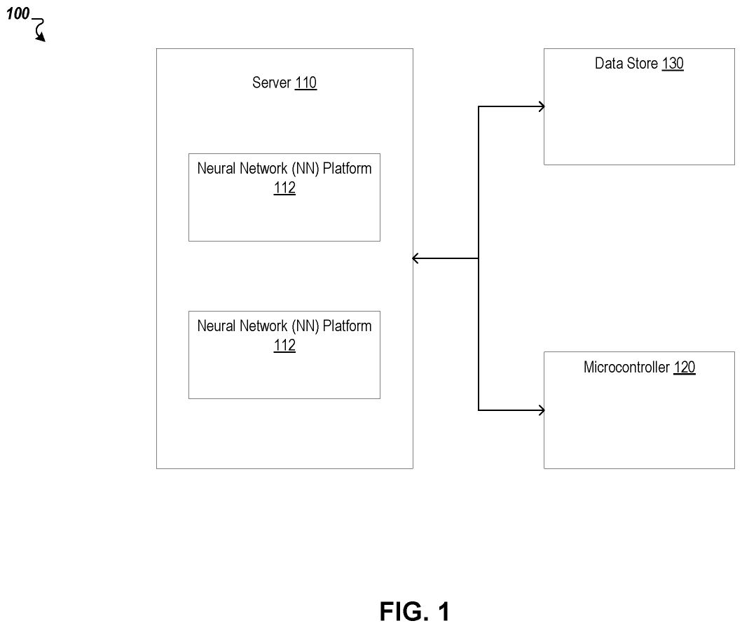

FIG. 1 illustrates an example system architecture 100, in accordance with implementations of the present disclosure. System architecture 100 (also referred to as “system” herein) includes a server 110 (also referred to as “server” herein) and a microcontroller 120 that are communicatively coupled to each other. System 100 also includes a data store 130 that is communicatively coupled to server 110. Server 110 may be a computing device (e.g., a desktop computer, a laptop computer, a mainframe computer, a server computer, etc.).

In some implementations, data store 130 is a persistent storage capable of storing trained neural networks. Data store 130 can be hosted by one or more storage devices, such as main memory, magnetic or optical storage-based disks, tapes or hard drives, NAS, SAN, and so forth. In some implementations, data store 130 can be a network-attached file server, while in other embodiments, data store 130 can be some other type of persistent storage such as an object-oriented database, a relational database, and so forth, that may be hosted by server 110 via the network.

Server 110 includes a neural network (NN) platform 112 that provides a user the ability to create, train, and deploy a neural network (NN). NN platform 112 may import all necessary libraries for building the neural network (e.g., libraries for numerical operations, data handling, and building NNs). NN platform 112 allows users to load and preprocess data, which includes normalizing and/or standardizing the data, handling missing values, and splitting the data into training and test sets. Users define an architecture of the NN by specifying in the NN platform 112 characteristics of the architecture, such as the number of layers in the NN, number of nodes in each layer, type of activation functions for each layer in the NN, etc. Once the architecture of the NN has been defined, NN platform 112 compiles the NN by specifying characteristics that govern the training and evaluation process, such as the optimizer, loss function, and other metrics. NN platform 112 trains the compiled NN by specifying the training data (or set), the number of epochs (iterations over the entire dataset), and the batch size (the number of samples per gradient update). The trained NN is evaluated by the NN platform 112 based on unseen data (e.g., test set). If NN platform 112 determines that the results of the evaluation are satisfactory (e.g., meeting predefined performance criteria), the trained NN can be used for inferencing (e.g., making predictions on new and unseen data). NN platform 112 may store (or deploy) the trained NN in an environment, such as a production environment, data store 130, or microcontroller 120. Storing the trained NN requires storing the weights and biases of the trained NN (which together form the “model”) so that they can be used to make predictions in the future.

NN platform 112 may store the trained NN in an environment (e.g., an identified environment). Depending on the resources of the environment, NN platform 112 can either store the trained NN directly in the identified environment without modification if the identified environment is an environment with ample resources and memory (e.g., data store 130) or reduce the trained NN and store the reduced trained NN in the identified environment if the identified environment is an environment with limited computational resources and memory (e.g., microcontroller 120). If NN platform 112 determines that the identified environment is an environment with limited computational resources and memory (e.g., microcontroller 120), NN platform 112 forwards the trained NNN to the encoding component 114. In some embodiments, NN platform 112 may forward the trained NN to the encoding component 114 regardless of the computational resources and memory of the identified environment.

Encoding component 114 may receive a sparse array associated with the trained NN. The sparse array includes a plurality of elements. Each element of the sparse array has a zero value or a non-zero value and represents a parameter of the trained NN. The sparse array is generated by performing a pruning operation (e.g., weight pruning, neuron pruning, structured pruning, iterative pruning, magnitude pruning, etc.) on the trained NN. In some embodiments, the pruning operation may be performed by the encoding component 114 or another component of the NN platform 112.

In some embodiments, encoding component 114 determines whether one or more group data structures can be generated for each group size of a plurality of group sizes. In some embodiments, the plurality group sizes may be a predetermined set of group sizes. The predetermined set of group sizes may be, for example, 16, 12, 8, and 4. In some embodiments, encoding component 114 sequentially determines whether one or more group data structures can be generated for a specific group size, starting with the largest group size of the plurality of group sizes (e.g., 16) to a smallest group size of the plurality of group sizes (e.g., 4).

Encoding component 114 determines whether one or more group data structures can be generated for the specific group size by iteratively adjusting a distance between elements of the sparse array and/or an offset from a first position in the sparse array. In some embodiments, the distance may be a distance of a plurality of distances. More specifically, encoding component 114 iterates through the sparse array from a specific offset (e.g., the first element in the sparse array) and identifies each element at every specific distance (e.g., the distance away from the previous element), including the element at a position associated with the offset in the sparse array (e.g., identified grouping).

Encoding component 114 determines whether at least a predetermined number of elements of the identified grouping has a non-zero value to obtain the identified grouping. The predetermined number of elements of the identified grouping having non-zero values may be based on a fraction of the group size. In some embodiments, the predetermined number of elements of the identified grouping having non-zero values may be a fraction of the group size. Responsive to determining that less than a predetermined number of elements of the identified grouping has a non-zero value, encoding component 114 disregards the identified grouping (or proceeds to obtaining the next identified grouping) due to the fact that the identified grouping contains too many zero valued elements.

In some embodiments, encoding component 114 may determine whether the number of elements of the identified grouping having zero values exceeds a zero-count threshold. In some embodiments, the zero-count threshold may be a predetermined value of 0, indicating that no element of the identified grouping should have a zero value. In some embodiments, the zero-count threshold may be a predetermined value of 1, indicating that no more than one element of the identified grouping should have a zero value. In some embodiments, the zero-count threshold may be determined as a fraction of the group size.

Responsive to determining that the number of elements of the identified grouping having a zero value does not exceed the zero-count threshold, encoding component 114 creates a group data structure including the identified grouping, the specific distance, and the specific offset used to obtain the identified grouping. Responsive to determining that the number of elements of the identified grouping having a zero value exceeds the zero-count threshold, encoding component 114 disregards the identified grouping (or proceeds to obtaining the next identified grouping) due to the fact that the identified grouping contains too many zero valued elements.

Once the group data structure is created, encoding component 114 may override a value of each element in the sparse array that was included in the identified grouping with a zero value. Accordingly, the elements included in the identified grouping are likely not to be added to later identified grouping. Encoding component 114, prior to proceeding to the next group size of the plurality of group sizes, repeats obtaining identified groupings, determining whether to disregard the obtained identified groupings or to create a group data structure for each of the obtained identified groupings, and overriding the elements included in the obtained identified groupings.

As a result, encoding component 114 may have multiple group data structures associated, each associated with an identified grouping extracted from the sparse array associated with the trained NN (e.g., multiple group encodings). Depending on the embodiment, some additional elements in the sparse array that were unable to be included in a group data structure may remain (e.g., remaining elements). Accordingly, encoding component 114 may utilize existing encoding techniques to encode the remaining elements (e.g., remaining elements encoding). Encoding component 114 may transmit (or forward) the group encodings (and, in some cases, the remaining elements encoding) to the NN platform 112 to be stored. NN platform 112 may store the group encodings associated with the trained NN in the identified environment.

Depending on the embodiment, instead of modifying the sparse array to generate the multiple group encodings, a copy of the sparse array may be generated and modified. More specifically, encoding component 114 may receive a sparse array associated with the trained NN. Encoding component 114 generates a copy of the sparse array (e.g., replica sparse array) in which each element with a non-zero value is replaced with a predetermined number (e.g., 1).

Encoding component 114 generates a plurality of sample arrays for each group size of a plurality of group sizes. Each sample array of the plurality of sample arrays associated with a specific group size includes a number of non-zero elements (represented as “1”s) that match the specific group size. Each sample array of the plurality spaces out the elements by a specific distance. Accordingly, the plurality of sample arrays associated with the specific group size should include a number of sample arrays that match a number of distances of the plurality of distances (e.g., 16 sample arrays).

Encoding component 114, starting with the largest group size of the plurality of group sizes (e.g., 16) to the smallest group size of the plurality of group sizes (e.g., 4), compares each sample array of the plurality of sample arrays associated with a respective group size. Encoding component 114, periodically aligns a first position of a respective sample array with each position of the replica sparse array, starting with a first position in the replica sparse array to a last position in the sparse array. Encoding component 114, with each alignment, compares values of the respective sample array with values of the replica sparse array. Encoding component 114, based on values of the respective sample array matching values of the replica sparse array at a specific alignment, obtains elements, from the sparse array, based on indexes in the replica sparse array having non-zero values that match non-zero values of the respective sample array (e.g., obtained elements). Encoding component 114 creates a group data structure including the obtained elements, the specific distance used to space out the elements in the respective sample array, and an offset in the replica sparse array associated with the current alignment of the sample array. Encoding component 114 replaces each value in the replica sparse array having non-zero values that match the non-zero values of the respective sample array with zero values.

For example, NN platform 112 may store the group encodings (and in some of the remaining elements encoding) associated with the trained NN in memory of microcontroller 120 (e.g., the identified environment). Microcontroller 120 may reconstruct a sparse array associated with the trained NN from the group encodings. Microcontroller 120 may retrieve the stored group encodings from memory. Microcontroller 120 initializes a reconstructed sparse array data structure. Microcontroller 120 processes each group encoding of the group encodings. Microcontroller 120 processes a respective group encoding of the group encodings by identifying a location in the reconstructed sparse array data that matches the offset of the respective group encoding (e.g., identified location). Microcontroller 120 iterates through each element of the identified grouping of the respective group encoding and, starting at the identified location, inputs into the reconstructed sparse array data structure a value associated with a respective element of the identified grouping at every specific distance of the respective group encoding. Depending on the ability of the microcontroller 120 to perform parallel processing, microcontroller 120 may process the insertion procedure for multiple values associated with the identified grouping in parallel. In some implementations, microcontroller 120 may use the reconstructed location of each element of the identified grouping to directly retrieve a corresponding element and perform subsequent computations.

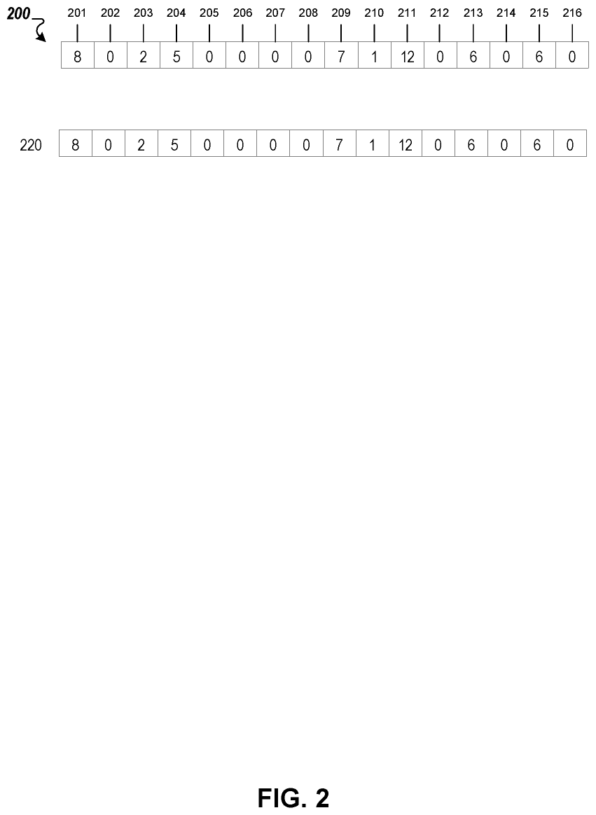

FIG. 2 is an exemplary illustration of the groupwise encoding of a sparse array of a trained neural network starting with a largest group size, in accordance with implementations of the present disclosure. As described with respect to FIG. 1, sparse array 200 is the sparse array associated with the trained NN received by the encoding component 114 of FIG. 1 from the NN platform 112 of FIG. 1. Sparse array 200 includes elements 201-216. Encoding component 114 starts with a first group size of the plurality of group sizes (e.g., 16). Encoding component 114 identifies elements from the sparse array 200 beginning with element 201 of the sparse array 200 and a distance of 0. Encoding component 114 obtains identified grouping 220 (e.g., 8, 0, 2, 5, 0, 0, 0, 0, 7, 1, 12, 0, 6, 0, 6, 0). Encoding component 114 determines that a number of elements of the identified grouping match the first group size. Encoding component 114 determines that a number of elements of the identified grouping having zero values exceed a zero-count threshold (e.g., 1). Depending on the embodiment, encoding component 114 may determine, based on that sparse array 200, that further adjustments to distance and/or offset would not produce any more newly identified groupings that satisfies the group size. Accordingly, rather than continue to obtain identified groupings at the group size, encoding component 114 selects (or proceeds) to the next smaller group size of the plurality of group size (e.g., 8).

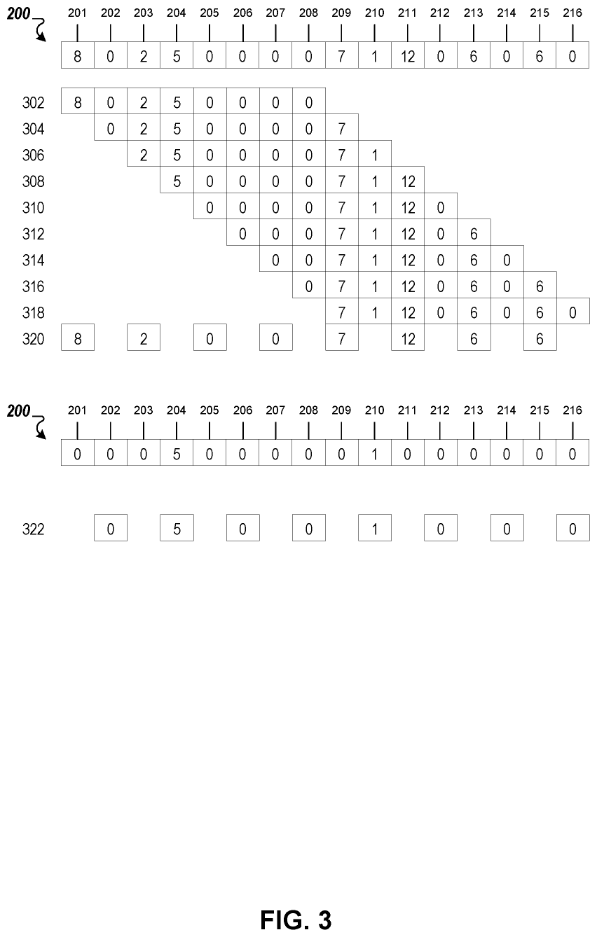

FIG. 3 is an exemplary illustration of the groupwise encoding of a sparse array of a trained neural network starting with a smaller group size, in accordance with implementations of the present disclosure. Encoding component 114 starts with a second group size of the plurality of group sizes (e.g., 8).

Encoding component 114 identifies, based on the group size, elements from the sparse array 200 beginning, based on an offset of 0, with element 201 of the sparse array 200 and a distance of 0. Encoding component 114 obtains identified grouping 302 (e.g., 8, 0, 2, 5, 0, 0, 0). Encoding component 114 determines that a number of elements of the identified grouping having zero values exceed the zero-count threshold. Encoding component 114 adjusts the offset from 0 to 1 to obtain a newly identified grouping.

Encoding component 114 identifies, based on the group size, elements from the sparse array 200 beginning, based on the adjusted offset, with element 202 of the sparse array 200 and a distance of 0. Encoding component 114 obtains identified grouping 304 (e.g., 0, 2, 5, 0, 0, 0, 0, 7). Encoding component 114 determines that a number of elements of the identified grouping having zero values exceed the zero-count threshold. Encoding component 114 adjusts the offset from 1 to 2 to obtain a newly identified grouping.

Encoding component 114 identifies, based on the group size, elements from the sparse array 200 beginning, based on the adjusted offset, with element 203 of the sparse array 200 and a distance of 0. Encoding component 114 obtains identified grouping 306 (e.g., 2, 5, 0, 0, 0, 0, 7, 1). Encoding component 114 determines that a number of elements of the identified grouping having zero values exceed the zero-count threshold. Encoding component 114 adjusts the offset from 2 to 3 to obtain a newly identified grouping.

Encoding component 114 identifies, based on the group size, elements from the sparse array 200 beginning, based on the adjusted offset, with element 204 of the sparse array 200 and a distance of 0. Encoding component 114 obtains identified grouping 308 (e.g., 5, 0, 0, 0, 0, 7, 1, 12). Encoding component 114 determines that a number of elements of the identified grouping having zero values exceed the zero-count threshold. Encoding component 114 adjusts the offset from 3 to 4 to obtain a newly identified grouping.

Encoding component 114 identifies, based on the group size, elements from the sparse array 200 beginning, based on the adjusted offset, with element 205 of the sparse array 200 and a distance of 0. Encoding component 114 obtains identified grouping 310 (e.g., 0, 0, 0, 0, 7, 1, 12, 0). Encoding component 114 determines that a number of elements of the identified grouping having zero values exceed the zero-count threshold. Encoding component 114 adjusts the offset from 4 to 5 to obtain a newly identified grouping.

Encoding component 114 identifies, based on the group size, elements from the sparse array 200 beginning, based on the adjusted offset, with element 206 of the sparse array 200 and a distance of 0. Encoding component 114 obtains identified grouping 312 (e.g., 0, 0, 0, 7, 1, 12, 0, 6). Encoding component 114 determines that a number of elements of the identified grouping having zero values exceed the zero-count threshold. Encoding component 114 adjusts the offset from 5 to 6 to obtain a newly identified grouping.

Encoding component 114 identifies, based on the group size, elements from the sparse array 200 beginning, based on the adjusted offset, with element 207 of the sparse array 200 and a distance of 0. Encoding component 114 obtains identified grouping 314 (e.g., 0, 0, 7, 1, 12, 0, 6, 0). Encoding component 114 determines that a number of elements of the identified grouping having zero values exceed the zero-count threshold. Encoding component 114 adjusts the offset from 6 to 7 to obtain a newly identified grouping.

Encoding component 114 identifies, based on the group size, elements from the sparse array 200 beginning, based on the adjusted offset, with element 208 of the sparse array 200 and a distance of 0. Encoding component 114 obtains identified grouping 316 (e.g., 0, 7, 1, 12, 0, 6, 0, 6). Encoding component 114 determines that a number of elements of the identified grouping having zero values exceed the zero-count threshold. Encoding component 114 adjusts the offset from 7 to 8 to obtain a newly identified grouping.

Encoding component 114 identifies, based on the group size, elements from the sparse array 200 beginning, based on the adjusted offset, with element 209 of the sparse array 200 and a distance of 0. Encoding component 114 obtains identified grouping 318 (e.g., 7, 1, 12, 0, 6, 0, 6, 0). Encoding component 114 determines that a number of elements of the identified grouping having zero values exceed the zero-count threshold. Depending on the embodiment, encoding component 114 may determine, based on that sparse array 200, that further adjustments to the offset would not produce any more newly identified groupings that satisfy the group size. Accordingly, encoding component 114 may reset the offset and adjust the distance from 0 to 1 to obtain a newly identified grouping.

Encoding component 114 identifies, based on the group size, elements from the sparse array 200 beginning, based on the offset of 0, with element 201 of the sparse array 200 and the adjusted distance of 1. Encoding component 114 obtains identified grouping 320 (e.g., 8, 2, 0, 0, 7, 12, 6, 6). Encoding component 114 determines that a number of elements of the identified grouping having zero values does not exceed the zero-count threshold. Encoding component 114 creates a group data structure, including the offset (e.g., the position of the element 201), the identified grouping 320, and the distance (e.g., 1). Encoding component 114 stores the group data structure. Encoding component 114 updates the sparse array 200 by replacing each element included in the group data structure with a zero value. The sparse array 200 is {0, 0, 0, 5, 0, 0, 0, 0, 0, 1, 0, 0, 0, 0, 0, 0).

Encoding component 114 identifies, based on the group size, elements from the sparse array 200 beginning, based on the offset of 0, with element 202 of the sparse array 200 and the adjusted distance of 1. Encoding component 114 obtains identified grouping 322 (e.g., 0, 5, 0, 0, 1, 0, 0, 0). Encoding component 114 determines that a number of elements of the identified grouping having zero values exceed the zero-count threshold. Depending on the embodiment, encoding component 114 may determine, based on that sparse array 200, that further adjustments to distance and/or offset would not produce any more newly identified groupings that satisfies the group size. Accordingly, rather than continue to obtain identified groupings at the group size, encoding component 114 selects (or proceeds) to the next smaller group size of the plurality of group size (e.g., 4).

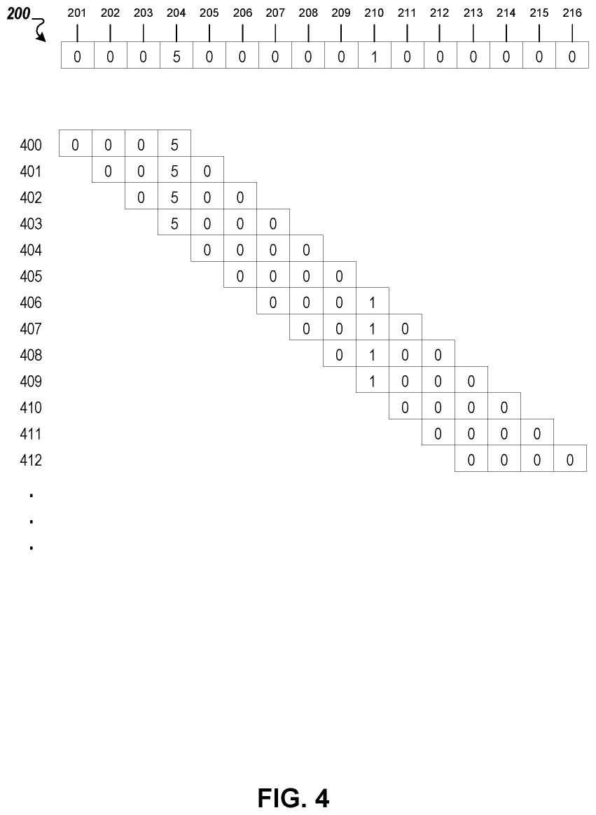

FIG. 4 is an exemplary illustration of the groupwise encoding of a sparse array of a trained neural network starting with an even smaller group size, in accordance with implementations of the present disclosure. Encoding component 114 starts with a third group size (e.g., last group size) of the plurality of group sizes (e.g., 4).

Encoding component 114 identifies, based on the group size, elements from the sparse array 200 beginning, based on an offset of 0, with element 201 of the sparse array 200 and a distance of 0. Encoding component 114 obtains identified grouping 400 (e.g., 0, 0, 0, 5). Encoding component 114 determines that a number of elements of the identified grouping having zero values exceed the zero-count threshold. Encoding component 114 adjusts the offset from 0 to 1 to obtain a newly identified grouping.

Encoding component 114 identifies, based on the group size, elements from the sparse array 200 beginning, based on an offset of 0, with element 202 of the sparse array 200 and a distance of 0. Encoding component 114 obtains identified grouping 401 (e.g., 0, 0, 5, 0). Encoding component 114 determines that a number of elements of the identified grouping having zero values exceed the zero-count threshold. Encoding component 114 adjusts the offset from 1 to 2 to obtain a newly identified grouping.

Encoding component 114 identifies, based on the group size, elements from the sparse array 200 beginning, based on an offset of 0, with element 203 of the sparse array 200 and a distance of 0. Encoding component 114 obtains identified grouping 402 (e.g., 0, 5, 0, 0). Encoding component 114 determines that a number of elements of the identified grouping having zero values exceed the zero-count threshold. Encoding component 114 adjusts the offset from 2 to 3 to obtain a newly identified grouping.

Encoding component 114 identifies, based on the group size, elements from the sparse array 200 beginning, based on an offset of 0, with element 204 of the sparse array 200 and a distance of 0. Encoding component 114 obtains identified grouping 403 (e.g., 5, 0, 0, 0). Encoding component 114 determines that a number of elements of the identified grouping having zero values exceed the zero-count threshold. Encoding component 114 adjusts the offset from 3 to 4 to obtain a newly identified grouping.

Encoding component 114 identifies, based on the group size, elements from the sparse array 200 beginning, based on an offset of 0, with element 205 of the sparse array 200 and a distance of 0. Encoding component 114 obtains identified grouping 404 (e.g., 0, 0, 0, 0). Encoding component 114 determines that a number of elements of the identified grouping having zero values exceed the zero-count threshold. Encoding component 114 adjusts the offset from 4 to 5 to obtain a newly identified grouping.

Encoding component 114 identifies, based on the group size, elements from the sparse array 200 beginning, based on an offset of 0, with element 206 of the sparse array 200 and a distance of 0. Encoding component 114 obtains identified grouping 405 (e.g., 0, 0, 0, 0). Encoding component 114 determines that a number of elements of the identified grouping having zero values exceed the zero-count threshold. Encoding component 114 adjusts the offset from 5 to 6 to obtain a newly identified grouping.

Encoding component 114 identifies, based on the group size, elements from the sparse array 200 beginning, based on an offset of 0, with element 207 of the sparse array 200 and a distance of 0. Encoding component 114 obtains identified grouping 406 (e.g., 0, 0, 0, 1). Encoding component 114 determines that a number of elements of the identified grouping having zero values exceed the zero-count threshold. Encoding component 114 adjusts the offset from 6 to 7 to obtain a newly identified grouping.

Encoding component 114 identifies, based on the group size, elements from the sparse array 200 beginning, based on an offset of 0, with element 208 of the sparse array 200 and a distance of 0. Encoding component 114 obtains identified grouping 407 (e.g., 0, 0, 1, 0). Encoding component 114 determines that a number of elements of the identified grouping having zero values exceed the zero-count threshold. Encoding component 114 adjusts the offset from 7 to 8 to obtain a newly identified grouping.

Encoding component 114 identifies, based on the group size, elements from the sparse array 200 beginning, based on an offset of 0, with element 209 of the sparse array 200 and a distance of 0. Encoding component 114 obtains identified grouping 408 (e.g., 0, 1, 0, 0). Encoding component 114 determines that a number of elements of the identified grouping having zero values exceed the zero-count threshold. Encoding component 114 adjusts the offset from 8 to 9 to obtain a newly identified grouping.

Encoding component 114 identifies, based on the group size, elements from the sparse array 200 beginning, based on an offset of 0, with element 210 of the sparse array 200 and a distance of 0. Encoding component 114 obtains identified grouping 409 (e.g., 1, 0, 0, 0). Encoding component 114 determines that a number of elements of the identified grouping having zero values exceed the zero-count threshold. Encoding component 114 adjusts the offset from 9 to 10 to obtain a newly identified grouping.

Encoding component 114 identifies, based on the group size, elements from the sparse array 200 beginning, based on an offset of 0, with element 211 of the sparse array 200 and a distance of 0. Encoding component 114 obtains identified grouping 410 (e.g., 0, 0, 0, 0). Encoding component 114 determines that a number of elements of the identified grouping having zero values exceed the zero-count threshold. Encoding component 114 adjusts the offset from 10 to 11 to obtain a newly identified grouping.

Encoding component 114 identifies, based on the group size, elements from the sparse array 200 beginning, based on an offset of 0, with element 212 of the sparse array 200 and a distance of 0. Encoding component 114 obtains identified grouping 411 (e.g., 0, 0, 0, 0). Encoding component 114 determines that a number of elements of the identified grouping having zero values exceed the zero-count threshold. Encoding component 114 adjusts the offset from 11 to 12 to obtain a newly identified grouping.

Encoding component 114 identifies, based on the group size, elements from the sparse array 200 beginning, based on an offset of 0, with element 213 of the sparse array 200 and a distance of 0. Encoding component 114 obtains identified grouping 412 (e.g., 0, 0, 0, 0). Encoding component 114 determines that a number of elements of the identified grouping having zero values exceed the zero-count threshold. Depending on the embodiment, encoding component 114 may determine, based on that sparse array 200, that further adjustments to the offset would not produce any more newly identified groupings that satisfy the group size. Accordingly, encoding component 114 may reset the offset and adjust the distance from 0 to 1 to obtain a newly identified grouping.

Similar to FIGS. 2 and 3, encoding component 114 repeatedly adjusts the distance and/or offset to obtain newly identified groupings until, based on the sparse array 200, further adjustments to distance and/or offset would not produce any more newly identified groupings that satisfies the group size. Depending on the embodiment, since the group size is the smallest group size of the plurality of group size (e.g., 4), encoding component 114 may encode any remaining elements of the sparse array 200 using an existing encoding method.

It should be noted that the above-identified groupings used to create the multiple group data structures for sparse array 200 are not the only identified groupings that can be used. In some instances, other identified groupings, based on a different combination of offset and distance, which satisfy the group size and zero count threshold can be used to create multiple group data structures for sparse array 200. The combination may be based on leaving the sparse array 200 with the least remaining elements after creating the multiple data structures. For example, the multiple group data structure may include a first group data structure (identified grouping 402, offset “0,” and distance “2”) and a second group data structure (identified grouping 404, offset “8,” and distance “1”). Accordingly, the remaining elements of the sparse array 200 is “2.”

With respect to FIG. 2-4, in some embodiments, the adjustment of the distance may be exhausted for each group size before adjusting the offset. In other embodiments, any suitable order and/or combination is considered to obtain newly identified groupings.

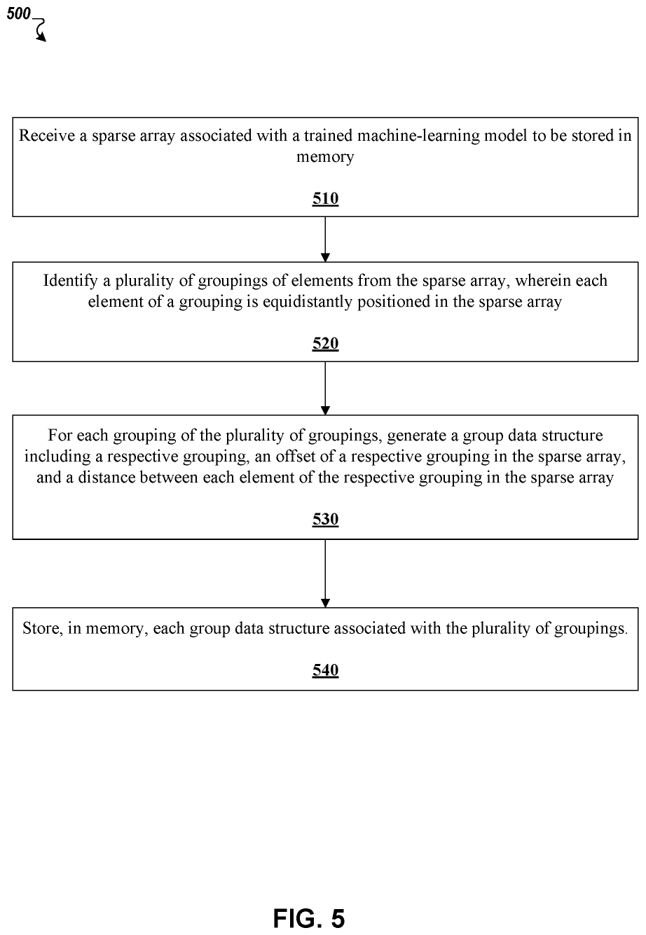

FIG. 5 depicts a flow diagram of an example method 500 for groupwise encoding of neural networks, in accordance with implementations of the present disclosure. Method 500 can be performed by processing logic that can include hardware (circuitry, dedicated logic, etc.), software (e.g., instructions run on a processing device), or a combination thereof. In one implementation, some, or all of the operations of method 500 can be performed by one or more components of system 100 of FIG. 1. In some embodiments, some or all of the operations of method 500 can be performed by encoding component 114, as described above.

At block 510, processing logic receives a sparse array associated with a trained machine-learning model to be stored in memory. As previously presented, the sparse array may include a plurality of elements, each element has a zero value or a non-zero value and represents a parameter of the trained NN, which is generated by a pruning operation.

At block 520, processing logic identifies a plurality of groupings of elements from the sparse array. Each element of a grouping is equidistantly positioned in the sparse array. For each group size of a plurality of group sizes, the processing logic identifies a subset of the plurality of groupings based on a respective group size. The group size may refer to a number of elements to be included in a grouping of the subset.

The processing logic adjusts the distance between elements to be included in the grouping of the subset between a range of distance. For each adjusted distance value, the processing logic determines whether a number of zero elements of the selected elements exceeds a zero-count threshold. Depending on the embodiment, the zero-count threshold may be a fraction of the group size. Responsive to determining that the number of zero elements of the selected element does not exceed the zero-count threshold, the processing logic includes the selected elements as the grouping of the subset. The processing logic selects, based on an offset from a first position in the sparse array to an end of the sparse array, elements from the sparse array with every respective adjusted distance value. The first position in the sparse array is periodically adjusted. The processing logic determines whether a number of the selected elements match the respective group size. The processing logic replaces each non-zero element of the grouping in the sparse array with a zero value.

At block 530, for each grouping of the plurality of groupings, processing logic generates a group data structure including a respective grouping, an offset of a respective grouping in the sparse array, and a distance between each element of the respective grouping in the sparse array. At block 540, processing logic stores, in memory, each group data structure associated with the plurality of groupings.

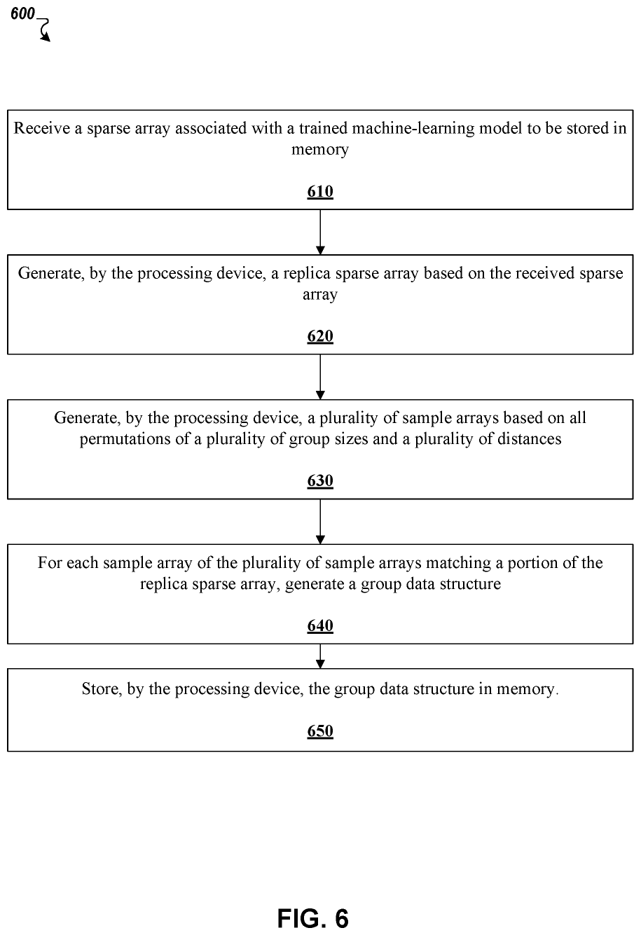

FIG. 6 depicts a flow diagram of an example method 600 for groupwise encoding of neural networks, in accordance with implementations of the present disclosure. Method 600 can be performed by processing logic that can include hardware (circuitry, dedicated logic, etc.), software (e.g., instructions run on a processing device), or a combination thereof. In one implementation, some, or all of the operations of method 600 can be performed by one or more components of system 100 of FIG. 1. In some embodiments, some or all of the operations of method 600 can be performed by encoding component 114, as described above.

At block 610, processing logic generates a replica sparse array based on the received sparse array. As previously presented, the sparse array may include a plurality of elements, each element has a zero value or a non-zero value and represents a parameter of the trained NN, which is generated by a pruning operation. The processing logic generates a copy of the sparse array, replacing elements of the copy of the sparse array with a non-zero value with a predetermined value. The processing logic returns the copy of the sparse array with the replaced elements as the replica sparse array.

At block 620, processing logic generates a plurality of sample arrays based on all permutations of a plurality of group sizes (e.g., 16, 12, 8, and 4) and a plurality of distances (e.g., a range of values based on the respective group). In particular, for each group size of the plurality of group sizes, the processing logic generates a subset of the plurality of sample arrays. Each sample array of the subset includes a number of elements with a non-zero value matching a respective group size spaced apart based on a distance value of the plurality of distance values.

At block 630, for each sample array of the plurality of sample arrays matching a portion of the replica sparse array, processing logic generates a group data structure. In particular, for each sample array of the plurality of sample arrays, the processing logic periodically aligns a respective sample array with the replica sparse array by adjusting an offset on the replica sparse array in which a first element of the respective sample array is aligned with the offset on the replica sparse array. The processing logic determines, with each periodic alignment, whether values of the replica sparse array match values of the respective sample array. Responsive to determining that values of the replica sparse array match values of the respective sample array, the processing logic obtains, using each index associated with the matching non-zero values, an array of values from the sparse array. The processing logic generates the group data structure to include the array of values, the offset, and a distance value in which the elements with non-zero values are spaced apart. The processing logic further replaces elements associated with the matching non-zero values in the replica sparse array with a zero value.

At block 640, processing logic stores the group data structure in memory.

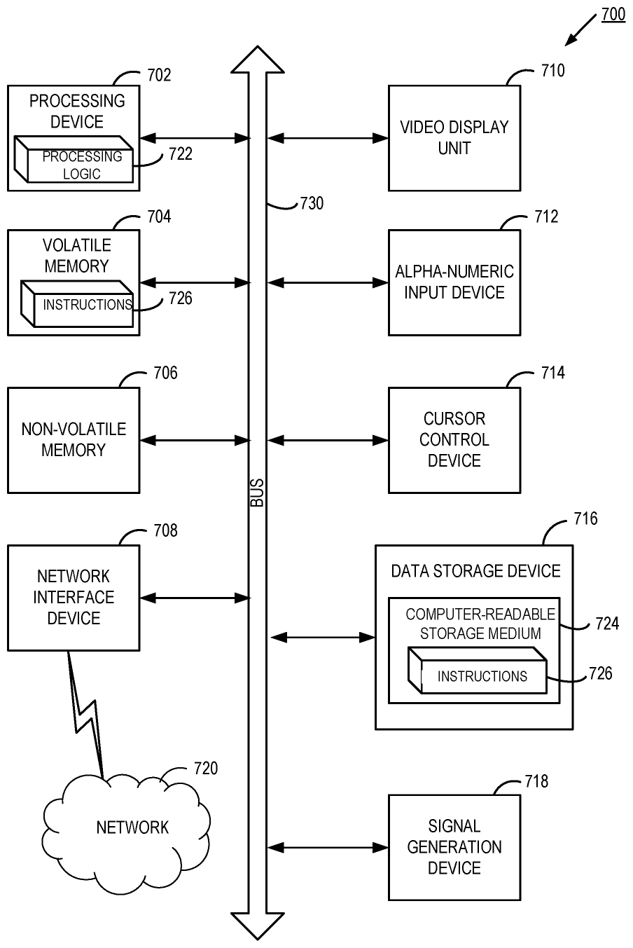

FIG. 7 is a block diagram illustrating an exemplary computer system 700, in accordance with implementations of the present disclosure. The computer system 700 can correspond to NN platform 112 and/or microcontroller 120, described with respect to FIG. 1. Computer system 700 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 750.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application-specific integrated circuit (ASIC), a field programmable gate array (FPGA), a digital signal processor (DSP), a network processor, or the like. The processor 702 is configured to execute instructions 726 (e.g., when executed provides groupwise encoding) for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, an alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 726 (e.g., when executed provides groupwise encoding) embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 726 include instructions for groupwise encoding. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution, and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving a sparse array associated with a trained machine-learning model to be stored in memory;
identifying a plurality of groupings of elements from the sparse array, wherein each element of a grouping is equidistantly positioned in the sparse array;
for each grouping of the plurality of groupings, generating a group data structure including a respective grouping, an offset of a respective grouping in the sparse array, and a distance between each element of the respective grouping in the sparse array; and
storing, in memory, each group data structure associated with the plurality of groupings.

2. The method of claim 1, wherein identifying the plurality of groupings comprises:
for each group size of a plurality of group sizes, identifying, based on a respective group size, a subset of the plurality of groupings, wherein the group size refers to a number of elements to be included in a grouping of the subset.

3. The method of claim 2, wherein identifying, based on the respective group size, the subset of the plurality of groupings comprises:
adjusting, between a range of distance values, a distance between elements to be included in the grouping of the subset;
for each adjusted distance value, determining whether a number of zero elements of the selected elements exceeds a zero-count threshold; and
responsive to determining that the number of zero elements of the selected elements does not exceed the zero-count threshold, including the selected elements as the grouping of the subset.

4. The method of claim 3, wherein the zero-count threshold is a fraction of the group size.

5. The method of claim 2, wherein the plurality of group size includes at least one of: 16, 12, 8, and 4.

6. The method of claim 3, wherein the range of distance values is based on a respective group size and indicates a number of elements between elements to be included in the grouping.

7. The method of claim 4, wherein including the selected elements as the grouping of the subset comprises:
replacing each non-zero element of the grouping in the sparse array with a zero value.

8. A system comprising:
a processing device to perform operations comprising:
receiving a sparse array associated with a trained machine-learning model to be stored in memory;
generating, by the processing device, a replica sparse array based on the received sparse array;
generating, by the processing device, a plurality of sample arrays based on all permutations of a plurality of group sizes and a plurality of distance values;
for each sample array of the plurality of sample arrays matching a portion of the replica sparse array, generating a group data structure; and
storing, by the processing device, the group data structure in memory.

9. The system of claim 8, wherein generating the replica sparse array comprises:
generating a copy of the sparse array;
replacing elements of the copy of the sparse array with a non-zero value with a predetermined value; and
returning the copy of the sparse array with the replaced elements as the replica sparse array.

10. The system of claim 8, wherein generating, based on all permutations of the plurality of group sizes and the plurality of distance values, the plurality of sample arrays comprises:
for each group size of the plurality of group sizes, generating a subset of the plurality of sample arrays, wherein each sample array of the subset includes a number of elements with a non-zero value matching a respective group size spaced apart based on a distance value of the plurality of distance values.

11. The system of claim 8, wherein generating the group data structure comprises:
for each sample array of the plurality of sample arrays, periodically aligning a respective sample array with the replica sparse array by adjusting an offset on the replica sparse array in which a first element of the respective sample array is aligned with the offset on the replica sparse array;
determining, with each periodic alignment, whether values of the replica sparse array match values of the respective sample array;
responsive to determining that values of the replica sparse array match values of the respective sample array, obtaining, using each index associated with the matching non-zero values, an array of values from the sparse array; and
generating the group data structure including the array of values, the offset, and a distance value in which the elements with non-zero values are spaced apart.

12. The system of claim 11, wherein obtaining, using each index associated with the matching non-zero values, the array of values from the sparse array, replacing elements associated with the matching non-zero values in the replica sparse array with a zero value.

13. The system of claim 11, wherein the plurality of group sizes includes at least one of: 16, 12, 8, and 4, and wherein the plurality of distance values is a range of values based on a respective group size.

14. A non-transitory computer-readable storage medium comprising instructions that, when executed by a processing device, cause the processing device to perform operations comprising:
receiving a sparse array associated with a trained machine-learning model to be stored in memory;
identifying a plurality of groupings of elements from the sparse array, wherein each element of a grouping is equidistantly positioned in the sparse array;
for each grouping of the plurality of groupings, generating a group data structure including a respective grouping, an offset of a respective grouping in the sparse array, and a distance between each element of the respective grouping in the sparse array; and
storing, in memory, each group data structure associated with the plurality of groupings.

15. The non-transitory computer-readable storage medium of claim 14, wherein identifying the plurality of groupings comprises:
for each group size of a plurality of group sizes, identifying, based on a respective group size, a subset of the plurality of groupings, wherein the group size refers to a number of elements to be included in a grouping of the subset.

16. The non-transitory computer-readable storage medium of claim 15, wherein identifying, based on the respective group size, the subset of the plurality of groupings comprises:
adjusting, between a range of distance values, a distance between elements to be included in the grouping of the subset;
for each adjusted distance value, determining whether a number of zero elements of the selected elements exceeds a zero-count threshold; and
responsive to determining that the number of zero elements of the selected elements does not exceed the zero-count threshold, including the selected elements as the grouping of the subset.

17. The non-transitory computer-readable storage medium of claim 16, wherein the zero-count threshold is a fraction of the group size.

18. The non-transitory computer-readable storage medium of claim 15, wherein the plurality of group size includes at least one of: 16, 12, 8, and 4.

19. The non-transitory computer-readable storage medium of claim 16, wherein the range of distance values is based on a respective group size indicates a number of elements between elements to be included in the grouping.

20. The non-transitory computer-readable storage medium of claim 17, wherein including the selected elements as the grouping of the subset comprises:
replacing each non-zero element of the grouping in the sparse array with a zero value.
